(19) United States
(12) Patent Application Publication
(10) Pub. No.: US 2012/0171955 A1
(43) Pub. Date: Jul. 5, 2012

(54) ACTIVE RF CHANNEL ASSIGNMENT

(75) Inventors: Jeff Donald Drake, Louisville, KY (US); Robert Marten Bultman, Louisville, KY (US)

(73) Assignee: General Electric Company

(21) Appl. No.: 12/980,558

(22) Filed: Dec. 29, 2010

(51) Int. Cl. H04W 72/08; H04B 7/00

(52) U.S. Cl. 455/41.2; 455/509

(57) ABSTRACT

A method and system is disclosed that includes a controller that selects a frequency channel for a communication module joining a network of a home. Each module is assigned by the controller a frequency channel to communicate on that excludes channels already being used by a network of the home. Separate networks of a home are joined without communicating on the same frequency channel.

### BACKGROUND

This disclosure relates to energy management, and more particularly to energy systems and methods with time of use (TOU) and/or demand response (DR) energy programs. The disclosure finds particular application to utility systems and appliances configured to manage energy loads to consumers through a communicating consumer control device, such as a home energy gateway (HEG), programmable communicating thermostat (PCT), appliance controller, or the like.

Demand response (DR) appliances are configured to respond to incoming signals from utilities (e.g., for a load shedding event), and/or user inputs for modifying the operation of the appliance (e.g., for energy savings). Coupled with DR appliances a home energy manager (HEM) or home energy gateway (HEG) of a home network provides feedback to a user regarding the performance of the appliances. For example, a user may be able to monitor and/or modify the appliances' responses as well as get feedback on power consumption. In order to reduce high peak power demand, many utilities have instituted time of use (TOU) metering and rates which include higher rates for energy usage during on-peak times and lower rates for energy usage during off-peak times. As a result, consumers are provided with an incentive to use electricity at off-peak times rather than on-peak times and to reduce overall energy consumption of appliances at all times.

There is a need to provide a system that can automatically operate power consuming devices during off-peak hours in order to reduce consumer's electric bills and also to reduce the load on generating plants during on-peak hours. Active and real time communication of energy costs and consumption of appliances to the consumer will enable informed choices of operating the power consuming functions of the appliance.

Further, to better communicate between appliances of a home and inform the user about energy costs and usage there is a need to get specific inputs from all devices within the home area network (HAN) regarding the amount of power each device is consuming. This disclosure provides a means of acquiring data and more efficiently communicate to devices on the network.

### SUMMARY

More specifically, this disclosure provides an energy management system that can communicate to energy consuming devices of a home among multiple types of home networks at a home over different frequency channels. The system has a central controller, such as a home energy gateway that obtains power/energy data, demand response data, or other like data available from an energy provider, and then makes the data available to the appliances via communications over the home networks. To reduce interference during communication on the home networks, a channel selector is implemented within the controller for selecting a frequency channel for each communication module. The channel selector ensures that each communication module forming a network communicates on a different frequency channel from other communication modules on the network.

In one embodiment, multiple networks are formed by the home energy gateway and include smart devices, such as smart appliances or demand response appliance and the like. The devices each include a device controller and a communications module. The devices are capable of controlling their electrical load, and communications back and forth with a central controller of the home, such as with consumption information to and from the home energy gateway.

In another embodiment, a method for communicating data among a plurality of energy consuming devices with communication modules of an energy management system comprising a central controller with at least one memory storing executable instructions for the method is disclosed. A first frequency channel within a first home network of the home is to communicate on by a first communication module of the controller. The frequency channels that are used to communicate within the home to the energy consuming devices by the different communication modules are determined, as well as a second frequency channel for a second home network to communicate with by excluding frequency channels that are used to communicate within the home.

### BRIEF DESCRIPTION OF THE DRAWINGS

FIG. 1 is a schematic illustration of an energy management system; and

FIG. 2 is a flow diagram illustrating an example methodology for implementing an energy management system with a plurality of energy consuming devices having different components.

### DETAILED DESCRIPTION

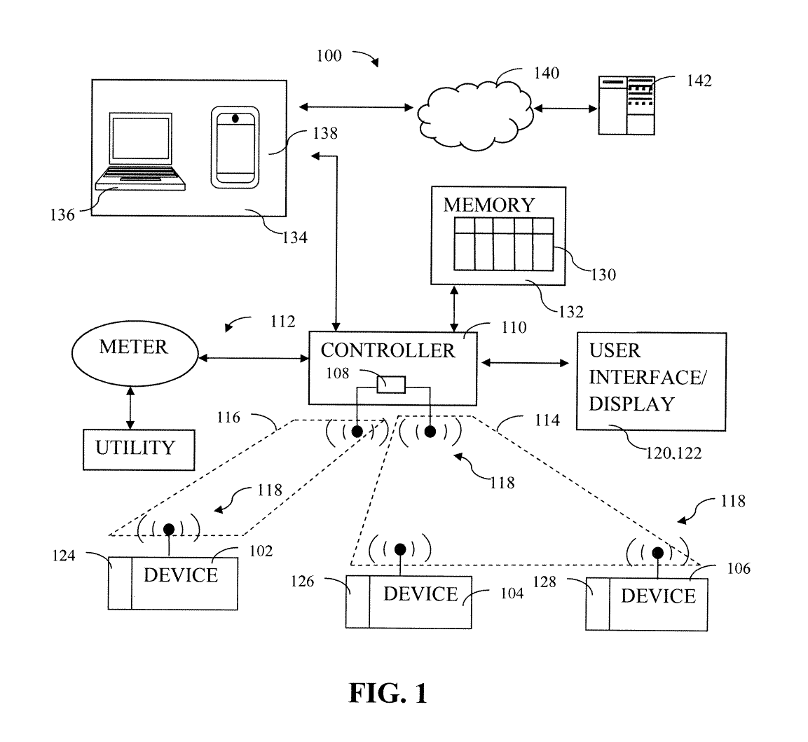

FIG. 1 schematically illustrates an exemplary home energy management system 100 for one or more energy consuming devices, such as devices 102, 104, 106 according to one aspect of the present disclosure. Each of the devices 102, 104, 106 can comprise one or more devices with one or more power consuming features/functions. For example, device 102 may be an appliance communication module with a processor or device controller, while devices 104 and/or device 106 may be a refrigerator, an HVAC system, a pool pump and/or any other energy consuming device capable of having power consumption measured at different times of operation and/or communication with a communication module. The devices, for example, may also be controllers, or other energy consuming devices other than appliances, such as programmable communicating thermostats that communicate on different networks of the home.

The home energy management system 100 comprises a central controller 110 for managing power consumption within a household. The controller 110 is operatively connected to each of the devices 102, 104, and 106 with power consuming features/functions within at least one home network 114, and 116, for example. The controller 110 includes a micro computer on a printed circuit board, which is programmed to selectively send signals over at least one frequency channel to a device control board 124, 126, 128 of devices 102, 104, 106 respectively in response to the input signal it receives. For example, demand response (DR) signals may be received and communicated to the devices by the device controller, which, in turn, is operable to manipulate energizing of the power consuming features/functions of the appliance.

In one embodiment, the central controller 110 is a home energy gateway (HEG) with a memory for processing and storing data, such as time of use (TOU) and/or DR program data. The central controller 110 is operable as a gateway device between a utility provider and appliances within the home. For example, the central controller 110 operatively couples information received at a meter of the home (e.g., smart meter or the like) with the energy consuming devices. Further, the controller 110 connects the devices on a home network with one another by a plurality of communication modules 118 that include at least a first and a second communication module. The controller 110 connects to a client application 134 in a personal computer 136 and/or a mobile device 138 to access the Internet 140 of FIG. 1. This allows for remote service and monitoring capability with the ability to communicate to devices on the network with various different protocols (e.g., 6LowPan/Zigbee, Ethernet, WiFi, etc.). A server 142 can also keep records of the home that may be accessed remotely via the interne.

The home area networks 114 and 116 communicate with the communication modules 118 in a communication protocol, and, for example, include a Zigbee network that communicates data in a Zigbee protocol format to communicating devices within the network. The home networks are not limited to Zigbee communication modules, but may also be a wired Ethernet network, a WiFi network (e.g., 802.11 b/g/n), or a Power Line Carrier network that communicates in respective protocol formats to devices within the network, such as the controller 110 and the devices 102, 104, or 106. Each device 102, 104 and/or 106 is joined to the network for communication via at least one communication module, and further, communicates on at least one frequency channel. This frequency channel is selected for communication by a channel frequency selector or a channel selecting component 108.

The channel frequency selector 108 facilitates communications in the system 100 by one or more communication modules, such as wireless and/or wired transceivers. For example, a first communication module 116 is operatively coupled to the meter for communicating to the central controller 110 with one of the communication modules 118 thereat. Each network of networks 114, 116 communicates on a different frequency channel that is selected by the channel selector 108. When each communication module 118 joins a network at the home with one or more of the energy consuming devices and their respective communication modules, a separate network is formed for specific communications between the controller 110 and the devices 102, 104, and 106. The modules are configured to provide communication with at least one frequency channel and a communication protocol that comprises a Zigbee, an Ethernet, a WiFi (e.g., 802.11 b/g/n), and a Power Line Carrier communication protocol, for example. This disclosure is not limited to any one particular communication protocol and other communication protocol formats may also be utilized as one of ordinary skill in the art can appreciate.

In addition, each network communicates via a different frequency channel from those that other communication modules communicate on. The controller 110 includes primary communication modules and the devices that the controller 110 communicates back and forth with include secondary communication modules, for example. The selection of a frequency channel for each communication module that is used to from a home network is controlled by the channel selector 108. Frequency channels already being used by communication modules on a home network, for example, are excluded by the channel selector 108 from being used in an algorithm of the selector 108 to select what frequency channel each communication module communicates on. The selector 108 is illustrated as being comprised by the controller 110, but the selector may be part of the communication module or located elsewhere also.

The channel selector 108 includes the algorithms for determining channels of communication for each communication module 118 at the controller 110 and at the devices 102, 104, and 106 joined on the networks. The disclosure is not limited to any one particular algorithm and multiple algorithms may be implemented. In one embodiment, each frequency channel is scanned or determined by the frequency channel selector and maintained in a list 130 of actively used frequency channels, for example. The list 130 of active frequency channels is stored in a memory 130 and may be updated as communication modules are added or taken offline with their respective networks.

In one embodiment, the channel selector 108 also determines the “quietest” channel to form a network with at least on communication module, while also excluding channels of networks that other communication modules are already communicating on. For example, a signal to noise ratio may be used to determine which frequency channels on the home network have the strongest signal and/or lowest amount of interference or noise on the network. Frequency channels of the predetermined signal to noise ratio, such as channels with maximum signal strength, are chosen by the selector as candidates to be available for other communication modules. Other measures or parameters of the frequency channels may also be used in the algorithm as one of ordinary skill in the art can appreciate. These frequency channel candidates are stored in the list 130, for example. Frequency channels that are not available and/or used by other communication modules actively are blacklisted or excluded from the list 130 as options for selection by the selector 108's algorithm.

As stated above, homeowners need to make informed decisions regarding their energy consumption use and cost. In general, a homeowner that is informed of energy consumption, such as their electricity usage, will find ways to reduce consumption. Therefore, devices, such as the devices 102, 104, 106 and any number of devices that may be added to the network, can be provided their consumption information through different communicating networks of the home. For example, the central controller 110 operates as a server for the secondary networks 116 and 118 of a home. Communication modules of each device at the home may be a transceiver or the like, for communicating data on the frequency channel selected by the selector 108. For example, demand response data, or TOU data that is provided by the utility, is transmitted from the central controller 110 to networks of the home. Because the devices are controlled by a device controller, each device is able to process power on and power off states therein. Consequently, each device 102, 104, 106 does not need to be authorized by a utility to join the utility networks or obtain measurement data directly from the meter 114, and as such, are joined each with a communication module at home, which is assigned a frequency channel by the selector 108.

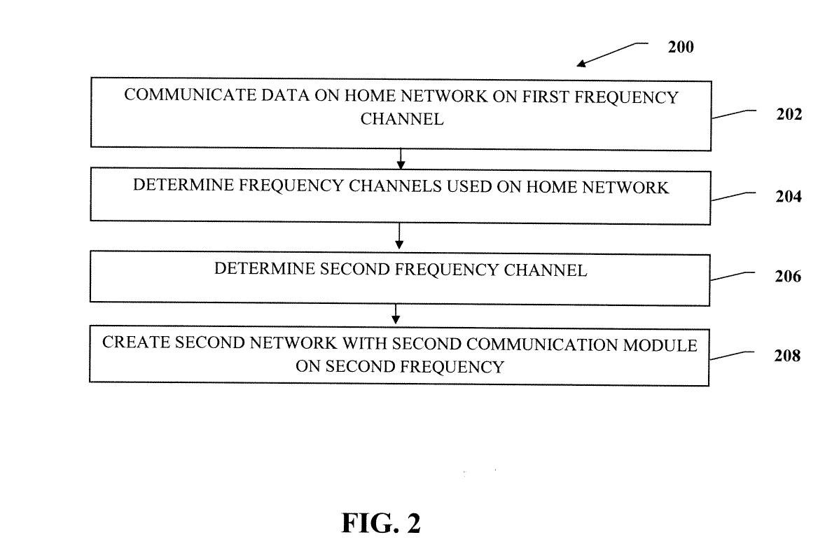

Example methodology 200 for a channel selector of an energy management system to assign a frequency channel in a home network is illustrated in FIG. 2. While the methods are illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

Referring now to FIG. 2, is an exemplary method for an energy management system of a home. The home includes a central controller 110, such as a home energy gateway, in which energy information is communicated through to the home. The controller is a processor, for example, that links networks at the home, for example. The controller 110 is coupled to at least one memory storing executable instruction or software and is operatively coupled to a power/energy measuring device or meter that measures power consumed at the home.

At 202 data is communicated via a first communication module of the controller 110 on a first frequency channel. For example, the energy provider or utility provider may communicate data in any communication protocol, such as a Zigbee communication protocol. A communication module 118 transmits the message received to a central controller 110, which then provides the data to networks at the home over the first frequency channel in a communication protocol format, such as a Zigbee cluster communication protocol, a WiFi protocol or a different communication protocol.

At 204 the frequency channels used for communicating on the home network are scanned by a frequency channel selector 108 in order to determine which channels are being used and/or are available at the home. In one embodiment, a list is maintained of the available or active frequency channels for the selector 108 to use when further communication modules are added to the system 100 or made active. The channel selector 108 utilizes and algorithm to determine the channel for each communication module joined on the network. By scanning the channels actively used on the home network, the selector 108 can update the list 130 stored in memories of channels already being used by other communication modules of the system. Alternatively, the list may be populated by another means rather than scanning with the selector 108 as one of ordinary skill in the art may appreciate. For example, another memory or device could be used to load data onto the memory 132 with the list 130 for use by the selector.

At 206, a second frequency channel is determined for a home network to communicate over based on the frequency channels scanned. The frequency channels that are used already to communicate are excluded in the algorithms of the frequency channel selector of a home energy gateway, for example. A second network is then created by the system at 208 that communicates among devices on the network with the second frequency channel. The second frequency channel may be a channel that is selected according to any signal measure, such as a maximum signal to noise ratio, with channels in the list being excluded from the measures.

The list is updated in one embodiment, to include active channels and non-active channels. It is updated according to the channels available for joining a network or a communication module of the system. The network utilizing the frequency channel includes one or more networks that communicate with the central controller of the home, for example. Each network can communicate on a frequency channel without interfering with communications of other networks. Further, multiple modules may be provided on a single network using different channels assigned by the selector 108.

An advantage of the present method 200 is that a pre-determined load shedding for an electrical load of the home can be implemented from electricity rates and/or schedules retrieved at a home with low interference communications. Additionally, real time feedback data can be provided to the energy consuming devices of each network with respect to energy usage occurring at the home over a different frequency for each network that prevent interference from occurring.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An energy management system having managed energy consuming devices for a home comprising:
a central controller that is in communication with the power/energy measuring device and the managed energy consuming devices and comprises:
a channel selecting component; and
a plurality of communication modules operable to communicate to different home networks;
wherein the channel selecting component scans frequency channels used by each of the communication modules and excludes those channels from being used by more than one home network for communication.

2. The system of claim 1, wherein each communication module joins a corresponding network to the controller comprising a home gateway device for communication to the managed energy consuming devices.

3. The system of claim 1, wherein the controller includes a primary communication module that is in communication with an energy provider via a smart meter and each of the plurality of communication modules include secondary communication modules that are each communicatively connected to one or more of the energy management devices of the home.

4. The system of claim 1, wherein the central controller is configured to monitor and manage energy consumption of each of the managed devices by sending communications to the managed energy devices over different networks on different frequency channels.

5. The system of claim 1, wherein the channel selecting component comprises an algorithm component that selects a channel with a maximum signal to noise ratio for at least one communication module to communicate on without including channels that are actively used by other communication modules from among the plurality of communication modules.

6. The system of claim 1, wherein the communication modules include an Ethernet, a WiFi, a Zigbee, and/or a Power Line Carrier communication module.

7. The system of claim 6, wherein the controller is configured to receive communications on at least one frequency channel on a first communication module thereat from at least one of the managed energy consuming devices and transmit the communications received to a different managed energy consuming device on a different frequency channel via a second communication module.

8. A method for communicating data among a plurality of energy consuming devices with communication modules, including an energy management system comprising a central controller with at least one memory storing executable instructions for the method, comprising:
communicating data on a first frequency channel within a first home network of the home via a first communication module of the controller;
determining frequency channels that are used to communicate within the home to the energy consuming devices by the different communication modules;
determining a second frequency channel for a second home network to communicate on based on the frequency channels that are used to communicate at the home;
creating a second network by communicating with a second communication module to one or more energy consuming devices on the second frequency channel;
wherein determining the second frequency channel includes selecting an available frequency channel while excluding the first frequency channel from being used by the second communication module.

9. The method of claim 8, wherein determining the second frequency channel includes selecting from a list of available frequency channels that excludes the first frequency channel and any of the frequency channels actively being by any other communication module to communicate to energy consuming devices within the home.

10. The method of claim 8, comprising:
retrieving data at the central controller through the primary home network from an energy provider; and
sending communications in response to the data retrieved from the controller to the energy consuming devices over different communication modules with a different frequency channel for each communication module.

11. The method of claim 10, comprising:
implementing a pre-determined load shedding for an electrical load of the home from electricity rates and/or schedules retrieved from the data via the communications from the energy provider by communicating to the energy consuming devices with the first frequency channel on the first home network and with the second frequency channel selected on a second home network.

12. The method of claim 11, comprising:
communicating with the power/energy measuring device and providing real time feedback data to the energy consuming devices of each network with respect to energy usage occurring at the home over a different frequency for each network.

13. The method of claim 8, wherein determining the second frequency channel includes determining a frequency channel with a maximum signal to noise ratio that is available from among the frequency channels that are used to communicate within the home and selecting from a list of available frequency channels that excludes any frequency channels actively used by communication modules to communicate to energy consuming devices within the home.

14. The method of claim 11, comprising:
retrieving communication from energy consuming devices on the first and the second home network on the first and the second frequency channel respectively.

15. A home energy gateway device for a home energy management system, comprising:
a plurality of communication modules that transmit and receive communication messages on at least one home network for energy consuming devices of a home;
a controller operatively connected to the communication modules that is configured to monitor and manage communications between each of the managed devices; and
a channel selector that determines a frequency channel for each communication module to communicate with to the energy consuming devices.

16. The device of claim 15, wherein the communication modules form multiple different home networks for communication with the energy consuming devices.

17. The device of claim 16, wherein the channel selector selects a frequency channel to be used by at least one of the communication modules by excluding frequency channels used by other communication modules operatively coupled to the controller and with respect to signal to noise ratio data.

18. The device of claim 15, wherein the channel selector includes a memory that stores each frequency channel that is actively used by each communication module in a list and updates the list when other frequency channels are used by added communication modules that form additional home networks at the home.

19. The device of claim 18, wherein the controller is configured to receive electricity rate and/or schedule information from an energy provider to communicate pre-determined load shedding commands for an electrical load of the energy consuming devices at the home.

20. The method of claim 14, wherein the communication modules include a first communication module and at least two secondary communication modules that respectively comprise a transceiver device for communicating with a smart meter, and the energy consuming devices over different frequency channels and are configured to reduce radio frequency interference while communicating on multiple home networks at a home.
